(19) United States
(12) Patent Application Publication
(10) Pub. No.: US 2006/0290102 A1
(43) Pub. Date: Dec. 28, 2006

(54) Weight Sensing Trailer Ball

(76) Inventor: William J. VanBuskirk JR., Lakebay, WA (US)

Correspondence Address: WHITAKER LAW GROUP, 755 WINSLOW WAY EAST, SUITE 304, BAINBRIDGE ISLAND, WA, 98110, US

(21) Appl. No.: 11/419,917

(22) Filed: May 23, 2006

Related U.S. Application Data
(60) Provisional application No. 60/693,258, filed on Jun. 22, 2005.

(51) Int. Cl. B60D 1/06

(52) U.S. Cl. 280/511

(57) ABSTRACT

A trailer ball includes in integral sensing mechanism to detect a force exerted on the trailer ball, such as the apparent weight of the tongue of a trailer. A display may be coupled to an output of the trailer for displaying the apparent tongue weight.

### CROSS REFERENCE TO RELATED APPLICATIONS

This application claims priority to pending U.S. Provisional Application No. 60/693,258 filed on Jun. 22, 2005 entitled Tongue Weight Trailer Ball.

### BACKGROUND

1. Technical Field

The present invention relates to the field of automotive accessories, and more particularly to the fields of trailer hitches and automotive safety promoting mechanisms.

2. Discussion of Related Art

Towing a trailer behind a vehicle can sometimes be difficult and even dangerous if the weight of the trailer is improperly balanced or exceeds the intended design of the vehicle. Exceeding the rated towing capacity of a vehicle can result in a very dangerous driving condition in addition to potential damage to the vehicle. For instance, dangerous trailer sway can occur by loading a trailer such that the proper proportions of “tongue weight” to gross weight are not achieved.

However, current technology does not provide an easy or convenient mechanism for measuring the tongue weight of a trailer. In fact, the almost-universally suggested method for measuring the tongue weight of a loaded trailer involves the use of a conventional bathroom scale, a brick, and a piece of wood. Such an awkward and inconvenient method of measuring the tongue weight of a trailer is, unfortunately, the state of the art.

The inventor is aware of one specific technique for measuring tongue weight other than the ones just described. The “Sherline” scale is a trailer tongue weight scale manufactured and sold by Sherline Products, Inc. of Vista, Calif. The Sherline scale is essentially a hydraulic scale that is designed to accept the weight of a trailer tongue to measure its tongue weight. Although slightly less awkward than the “bathroom scale” method, the Sherline scale suffers from the same drawback that the trailer must be disconnected from the trailer ball to measure its weight. In addition, a separate measuring device must be employed to weigh the trailer, which adds to the complexity of loading the trailer.

A superior mechanism and technique for measuring tongue weight has eluded those skilled in the art, until now.

### SUMMARY OF THE INVENTION

The invention is directed at a trailer ball that includes in integral sensing mechanism to detect a force exerted on the trailer ball, such as the apparent weight of the tongue of a trailer. A display may be coupled to an output of the trailer for displaying the apparent tongue weight.

In one aspect, the invention enables an apparatus comprising a trailer ball adapted to sense a force exerted on the trailer ball, the trailer ball being further configured to receive a tongue of a trailer; and a signal component coupled to the trailer ball and configured to output a signal substantially corresponding to the force.

In another aspect, the invention enables an apparatus comprising a trailer ball having an integrated sensor operative to detect a downward force imparted on a trailer hitch to which the trailer ball is attached while a trailer is coupled to the trailer ball and to convey the downward force to a display mechanism.

In yet another aspect, the invention enables an apparatus for displaying the tongue weight of a trailer comprising a display having a coupling that is operative to couple to a trailer ball, the display being configured to output an indication of a tongue weight of a trailer while the trailer is coupled to the trailer ball based on a signal received from the trailer ball using the coupling.

In still another aspect, the invention enables a method for measuring tongue weight. The method includes detecting a downward force exerted by a trailer tongue on a trailer ball with the trailer tongue coupled to the trailer ball, and outputting a signal that corresponds, at least in part, to the downward force.

Advantageously, embodiments of the invention enable a user to inspect the tongue weight of a trailer while the trailer is coupled to the trailer ball and without having to decouple the trailer from the trailer ball. In addition, weight can be redistributed on the trailer without decoupling the trailer from the trailer ball to achieve a desired tongue weight, which greatly simplifies the task of loading a trailer that is safe to tow.

### BRIEF DESCRIPTION OF THE DRAWINGS

The present invention will be understood and appreciated more fully from the following detailed description taken in conjunction with the referenced drawings, briefly described here:

FIG. 1 is a perspective view of one trailer ball constructed in accordance with the invention.

FIG. 2 is an exploded view of a trailer ball that implements one embodiment of the invention.

FIG. 3 is an exploded view of another trailer ball that implements another embodiment of the invention.

FIG. 4 is a graphical illustration of a trailer affixed to a trailer ball constructed in accordance with one embodiment of the invention.

FIG. 5 is a functional block diagram generally illustrating one implementation of the invention.

FIG. 6 is a functional block diagram generally illustrating another implementation of the invention.

FIG. 7 is a functional block diagram generally illustrating yet another implementation of the invention.

### EMBODIMENTS OF THE INVENTION

Embodiments of the invention measure the approximate downward force exerted by the tongue of a trailer on a trailer hitch. Generally stated, a trailer hitch ball (trailer ball) is modified to include a weight-sensing mechanism integral to the trailer ball, and a readout that can be viewed by a user to determine the apparent weight of an attached trailer at the trailer hitch (the “tongue weight”).

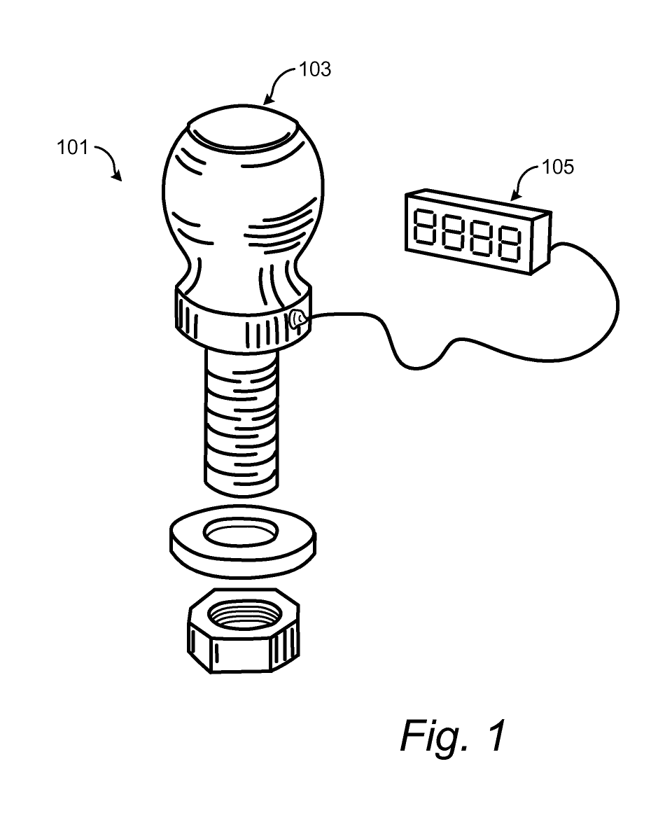

FIG. 1 is a perspective view of one trailer ball 101 constructed in accordance with the invention. Illustrated is a trailer ball 101 of the same general dimensions and proportions as a conventional trailer ball. However, in contrast to conventional trailer balls, the trailer ball 101 constructed in accordance with the invention is capable of detecting and outputting the tongue weight of a trailer. More specifically, the trailer ball 101 has a detection portion 103 that is configured to receive and detect the weight of an attached trailer. As is known in the art, a trailer is coupled to the trailer ball 101 such that, at least at rest, the weight of the tongue of the trailer is recognized at the top of the trailer ball 101 as a downward force. Accordingly, the trailer ball 101 is configured with a detection portion 103, which in general is at the top of the trailer ball 101. For the purpose of this document, the term “tongue weight” means an apparent downward force exerted by the tongue of a trailer at the detection portion 103 of the trailer ball 101.

The trailer ball 101 also includes an integrated sensor (not visible) for detecting weight. In this embodiment, the sensor is coupled to the detection portion 103 such that forces detected by the detection portion 103 (e.g., the top of the trailer ball) are transferred to the sensor. The sensor is further configured to transform the tongue weight into an output signal proportional to the detected weight. Examples of particular embodiments of such a sensor are detailed below.

Finally, the output signal of the sensor is made available to a display 105 which then creates a visually or other perceptible indication of the tongue weight. In one example, the display 105 may be a simple digital LED device that displays the tongue weight so that a user can visually inspect the tongue weight. In such a case, the display 105 may be provided with a signal that directly indicates the tongue weight, such as an electronic value that defines the detected tongue weight. In another example, the display may be an analog dial or gage configured to alter its indicator in proportion to a level, amplitude, pressure, or other property of the output signal.

In still another example, the display 105 could provide a binary representation of whether the tongue weight exceeds some threshold. For instance, the trailer ball 101 could be configured to output a signal only if the tongue weight exceeds some pre-determined threshold. In such a case, the sensor of the trailer ball 101 could be configurable with a value, such as the maximum safe tongue weight of the truck to which the trailer ball 101 is attached. So configured, the display 105 may include a simple two-state indication of whether the tongue weight exceeds the safe threshold. Similarly, the display 105 could include a graduated (e.g., three or four levels) that indicate whether the tongue weight exceeds certain discreet thresholds (e.g., safe, caution, dangerous) of tongue weight.

The display 105 illustrated in FIG. 1 is shown proximate to the trailer ball 101, which the inventor envisions as a common implementation. However, the display could also be located remotely, such as on the dashboard (or elsewhere) of the trailering vehicle. In such a case, a dongle or other wire could be plugged into the trailer ball 101 and extend to the remote location of the display. Alternatively, a wireless connection could be made between the trailer ball 101 and the display 105.

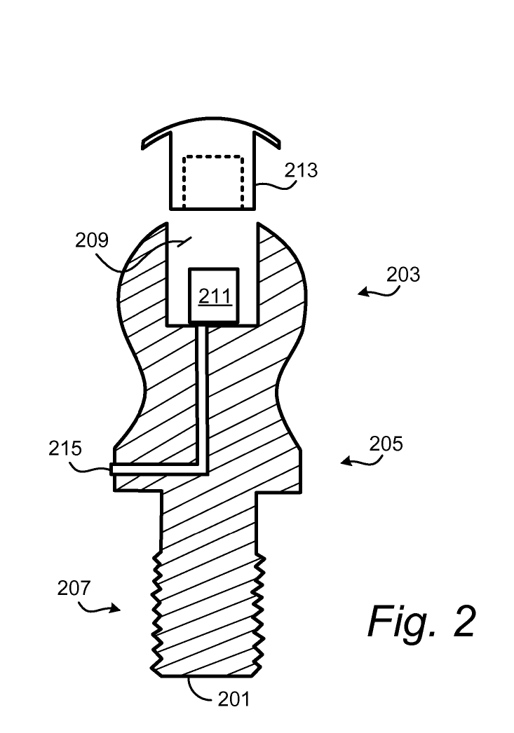

FIG. 2 is an exploded view of a trailer ball 201 that implements one embodiment of the invention. In this embodiment, the trailer ball 201 includes a body having a ball portion 203, a base portion 205, and a threaded shank portion 207. The ball portion 203 includes a cavity 209 in which rests a sensor 211. In this particular embodiment, the sensor 211 is a load cell. A load cell is a transducer that converts force into a measurable output signal. Typically, the conversion is achieved by the physical deformation of strain gages which are bonded into the load cell beam and wired into a wheatstone bridge configuration. There are many varieties of load cells, any of which may be appropriate in various implementations of the invention, such as strain-gage load cells that convert the load acting on them into electrical signals, hydraulic load cells that measure weight as a change in pressure of an internal filling fluid, and pneumatic load cells that also operate on the force-balance principle but which use multiple dampener chambers to provide higher accuracy than a hydraulic device. The selection of which particular load cell to use is a design consideration, and many different types could be used in different implementations of the invention.

Atop the sensor 211 rests a cap 213 that is slidably displaced within the cavity 209 of the ball portion 203. The cap 213 could be any component sufficiently rigid and sized to transfer a force exerted at the top of the cap 213 to the sensor 211. In this way, a downward force (e.g., the tongue weight of a trailer) applied to the cap 213 is transferred to the sensor 211 and converted into a signal. The signal corresponds to and represents the tongue weight. Ideally, but not necessarily, the signal is directly proportional to the tongue weight. In this embodiment, that signal may be transmitted or conveyed outside the trailer ball 201 using wires disposed within a channel 215 that exits the trailer ball 201 at the base 205. The wires may continue outside the trailer ball 201, or they may terminate at an output connector or port.

A remote display (not shown) may be coupled to the wires or output connector so as to create a usable presentation of the tongue weight, such as an LED or analog display. Alternatively, a display may be integrated into the trailer ball, such as at the base 205, so that a user can visually inspect the tongue weight directly on the trailer ball 201.

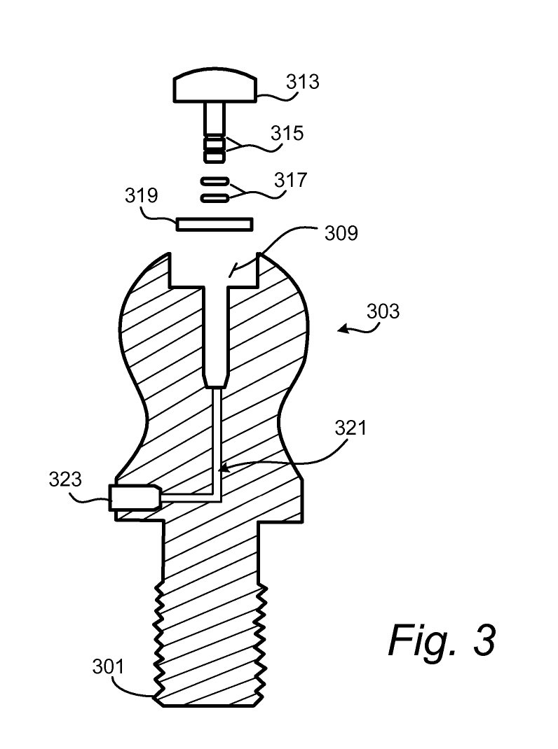

FIG. 3 is an exploded view of another trailer ball 301 that implements another embodiment of the invention. In this embodiment, the trailer ball 301 includes a body having a cavity 309 displaced within a ball portion 303. The cavity 309 forms a hydraulic reservoir or cylinder. The cavity 309 can be formed in any acceptable way, such as by boring a hole into the top of the trailer ball 301 or by casting the trailer ball 301 with the cavity 309. In this embodiment, the cavity 309 is filled with a hydraulic fluid such that the cavity 309 forms a hydraulic chamber.

A piston 313 is inserted into the cavity 309 thus creating a surface at the top of the trailer ball 301 which, when weight is applied, causes a compressive force on the hydraulic fluid within the cavity 309. The piston 313 may have O-ring grooves 315 and use O-rings 317 to seal the hydraulic fluid in the cavity 309. A compression gasket 319 provides a cushion for the piston 313 as it is compressed by the trailer tongue.

A hydraulic channel 321 couples the cavity 309 to an output port 323, such as a ⅛″ NPT Port. The ⅛″ NPT Port exits the base and can be drilled and taped to accept a hydraulic pressure measurement device. The compressive force on the hydraulic fluid is measured using any appropriate means, such as with a mechanical gage or an electronic display coupled to a pressure transducer. In this manner, the user is able to visibly determine the apparent tongue weight of the attached trailer.

When a trailer is mounted on a trailer ball 301 constructed in accordance with this implementation of the invention, the tongue weight imparts a downward force on the piston 313 on the top (generally speaking) of the trailer ball 301. The piston 313 exerts a force on the hydraulic fluid within the cavity 309 in direct proportion to the tongue weight of the attached trailer. The pressure created in the cavity 309 is transferred to the output coupling 323 through the hydraulic channel 321 where it is measured by some hydraulic measurement device, such as a mechanical gage or an electronic pressure transducer with display. The apparent tongue weight of the trailer is displayed, thus allowing the user to better balance the load on the trailer.

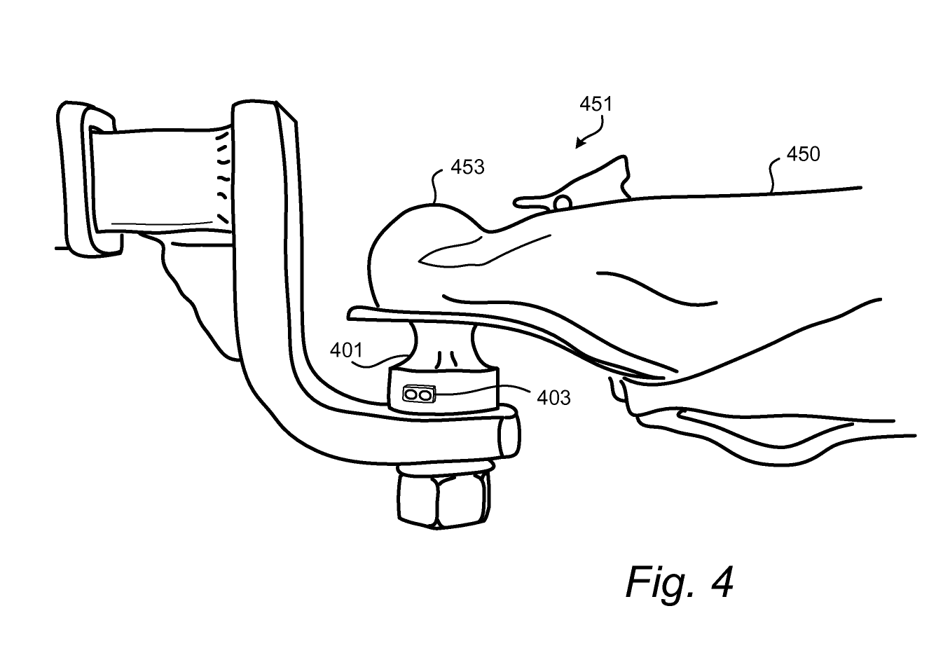

FIG. 4 is a graphical illustration of a trailer 450 affixed to a trailer ball 401 constructed in accordance with one embodiment of the invention. As illustrated, the tongue 451 of the trailer 450 includes a ball-shaped receptacle 453 that is sized slightly larger than the dimension of the ball portion of the trailer ball 401. Thus, the trailer tongue 451 accepts the trailer ball 401 into the ball receptacle 453 and is commonly locked into place. The tongue weight of the trailer 450 is apparent to the trailer ball 401 as a substantially downward force presented at the top of the trailer ball 401. In accordance with certain embodiments of the invention, the trailer ball senses the tongue weight of the trailer.

The trailer ball 401 includes an output port 403 into which a display mechanism or signal receiving mechanism may be connected. The trailer ball 401 outputs a signal that is proportional to or indicative of the tongue weight. Thus, a user can easily measure the tongue weight by coupling a display mechanism to the trailer ball. In some embodiments, the display mechanism can be disconnected from the trailer ball while towing or driving. In other embodiments, the display mechanism may remain connected to the trailer ball such as with wires or wirelessly. In still other embodiments, the display mechanism may be integrated into the trailer ball.

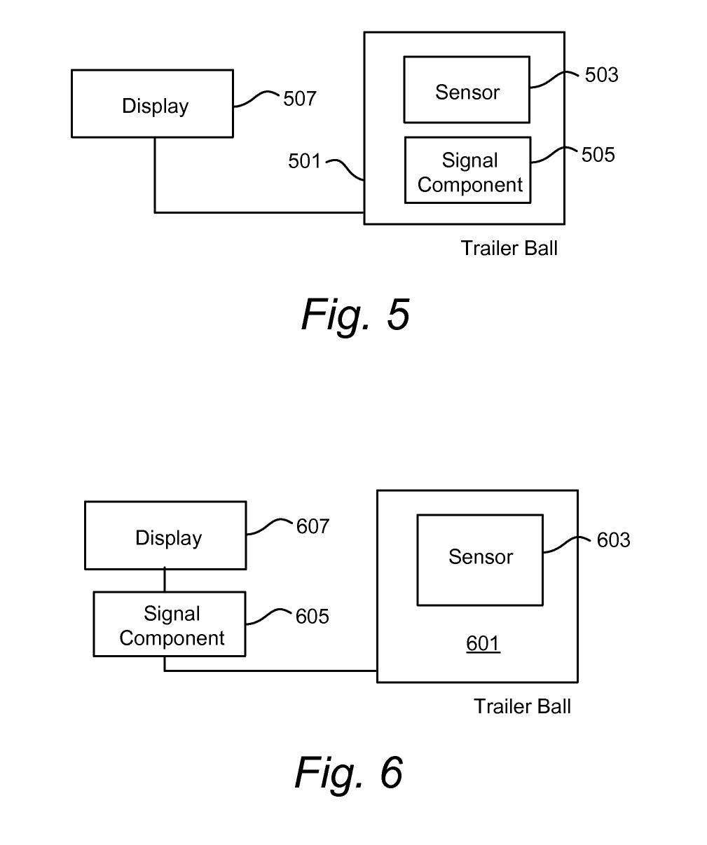

FIG. 5 is a functional block diagram generally illustrating one implementation of the invention. In this implementation, a trailer ball mechanism 501 includes an integrated sensor 503 and integrated signal component 505. The integrated sensor 503 is configured to detect a force exerted against the trailer ball 501 and to convert that force into a signal. In one example, the sensor may be a load cell. The integrated signal component 505 is configured to convert that signal into a weight measurement that can be coupled to an external display 507, such as with a wire, hydraulic pressure, wireless transmission, or the like. In one example, the signal component 505 may be circuitry for receiving signals from the load cell and for outputting a value that corresponds to those received signals.

FIG. 6 is a functional block diagram generally illustrating another implementation of the invention. In this implementation, a trailer ball mechanism 601 includes an integrated sensor 603 to detect a force exerted against the trailer ball 601. That force is converted into a signal which is provided by the trailer ball 601 to a signal component 605 for measuring the signal. In one implementation, the signal component 605 could be a circuit for measuring electrical signals. In another implementation, the component could be a hydraulic gage that measures hydraulic force. That component then provides its measurement to a display 607 for viewing or use by a user.

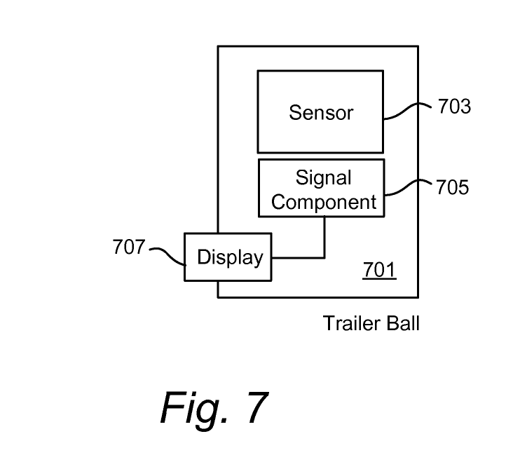

FIG. 7 is a functional block diagram generally illustrating yet another implementation of the invention. In this implementation, a trailer ball mechanism 701 includes an integrated sensor 703 and integrated signal component 705. The integrated sensor 703 is configured to detect a force exerted against the trailer ball 701 and to convert that force into a signal. The integrated signal component 705 is configured to convert that signal into a weight measurement, or the like, that can be coupled to a display 707 that is integrated at least in part, into the trailer ball mechanism 701.

Because many varying and different embodiments may be made within the scope of the inventive concept presented here, and because many modifications may be made in various embodiments of the invention, it is to be understood that the details of this disclosure are to be interpreted as illustrative and not limiting.

I claim:

1. An apparatus, comprising:
a trailer ball adapted to sense a force exerted on the trailer ball, the trailer ball being further configured to receive a tongue of a trailer; and
a signal component coupled to the trailer ball and configured to output a signal substantially corresponding to the force.

2. The apparatus recited in claim 1, wherein the trailer ball further includes an integrated sensor to sense the force.

3. The apparatus recited in claim 2, wherein the sensor comprises a load cell.

4. The apparatus recited in claim 2, wherein the sensor comprises a hydraulic chamber.

5. The apparatus recited in claim 1, wherein the trailer ball includes a shank portion operative to couple the trailer ball to a trailer hitch.

6. The apparatus recited in claim 5, wherein the shank portion is threaded.

7. The apparatus recited in claim 1, wherein the output signal is made available though an output connector.

8. The apparatus recited in claim 7, wherein a display is coupled to the output connector, the display being operative to produce an indication of the force exerted on the trailer ball.

9. The apparatus recited in claim 1, further comprising a display coupled to the trailer ball and operative to produce an indication of the force based on the output signal.

10. An apparatus, comprising:
a trailer ball having an integrated sensor operative to detect a downward force imparted on a trailer hitch to which the trailer ball is attached while a trailer is coupled to the trailer ball and to convey the downward force to a display mechanism.

11. The apparatus recited in claim 10, wherein conveying the downward force is performed by a signal component operative to receive an indication of the downward force from the sensor and to transform the downward force into an output signal corresponding to the downward force, the signal component being configured to convey the output signal to the display mechanism.

12. The apparatus recited in claim 10, wherein the sensor comprises a load cell.

13. The apparatus recited in claim 10, wherein the sensor comprises a hydraulic chamber.

14. The apparatus recited in claim 10, wherein the trailer ball comprises a ball portion and a shank portion, the ball portion having a cavity in which resides the integrated sensor.

15. An apparatus for displaying the tongue weight of a trailer, comprising:
a display having a coupling that is operative to couple to a trailer ball, the display being configured to output an indication of a tongue weight of a trailer while the trailer is coupled to the trailer ball based on a signal received from the trailer ball using the coupling.

16. A method for measuring tongue weight, comprising:
detecting a downward force exerted by a trailer tongue on a trailer ball with the trailer tongue coupled to the trailer ball; and
outputting a signal that corresponds, at least in part, to the downward force.

17. The method recited in claim 16, further comprising displaying an indication of the output signal.
